(19) United States
(12) Patent Application Publication
(10) Pub. No.: US 2004/0071808 A1
(43) Pub. Date: Apr. 15, 2004

(54) Method and device for producing shaped bodies, especially capsules, from a biopolymer material containing starch

(76) Inventors: Alois Peter, Wil (CH); Valentin Lutz, Bronschhofen (CH); Rico Menard, Kirchberg (CH)

Correspondence Address: Nath & Associates, Sixth Floor, 1030 Fifteenth Street NW, Washington, DC, 20005, US

(21) Appl. No.: 10/451,936

(22) PCT Filed: Dec. 15, 2001
(86) PCT No.: PCT/EP01/14837

(30) Foreign Application Priority Data
Dec. 29, 2000 (EP) 00128701.0

(51) Int. Cl. B29C 47/90

(52) U.S. Cl. 425/133.5; 425/71; 425/215

(57) ABSTRACT

A device for producing shaped bodies comprising at least one extrusion tool (1) for extruding an endless strip of material (15) and at least one form tool (2) used to process the material strip in order to form shaped bodies, especially capsules, in addition to a treatment station (3) which is used to impinge upon the material strip with heat. According to the invention, the material strip undergoes heat treatment at least once between the extrusion tool and the form tool in order to relieve stress.

The invention relates to a method and a device for producing shaped bodies, especially capsules, from a biopolymer material containing starch, according to the preambles of independent claims 1 and 8.

Shaped bodies, especially capsules, are today produced in continuous, automatable processes from endless material strips. Especially in the case of one-part soft capsules, the production of the shell of the shaped body and the filling of the same takes place in a single working step. In these continuous processes, shaped parts are fabricated, and from them the capsule shells are joined together during and after filling by fusing the outer edges of the shaped parts. The fabrication of the shaped parts takes place either by means of molds moving apart and together, such as for example in the Norton, Banner or Scherer process, or by means of rotating forming rolls, as realized for example in the rotary-die process and in the Accogel process (“Die Kapsel” [the capsule], by Fahrig/Hofer, Stuttgart, 1983; Lachmann/Liebermann/Kanig, “The Theory and Practice of Industrial Pharmacy”; Third Edition, Philadelphia 1986). The filling takes place with the aid of metering pumps, which discharge a defined amount of active substance during the punching out and fusing of the shaped parts to form a one-part capsule shell. The fusing, i.e. the forming of the seams, generally takes place by pressure and heat.

The production process for shaped bodies from endless material strips in this case presents a series of requirements. One of the main prerequisites is the ability to form endless material strips of adequate strength which have adequate elongation at break and elasticity.

If gelatin is used as the base material, material strips which meet all these conditions in a virtually ideal way can be produced.

Gelatin strips, especially for soft gelatin capsules, can be produced from a homogeneous composition of gelatin and water which is capable of flowing well at 40° C. to 80° C. and usually also contains additives such as glycerol and sorbitol. This takes place under atmospheric pressure, the composition being poured or extruded from so-called spreaders under gravity through a slot onto a chilled drum. A method of this type has already been disclosed by U.S. Pat. No. 3,092,942. In this case, the composition is intended to solidify at about 15° C. to 25° C. (gel state). At lower extrusion temperatures, the water content must be increased, in order to lower the melting point and viscosity, or extrusion must be carried out under pressure. In the case of extrusion temperatures above 100° C., there is the risk of the mixture foaming as it emerges from the so-called spreader.

It has been found that the pressureless extrusion technique normally used in the case of gelatin strips cannot be transferred to biopolymers which contain starch and water, and also possibly additives such as glycerol or sorbitol, since the water-containing films cannot be handled well even at temperatures far below the extrusion temperature, because of inadequate mechanical properties. A gel state is not obtained, or the softening or melting range is very great, with the result that strength is not achieved at low temperatures, while adequate flowing properties are still not obtained at temperatures around 100°. The production of corresponding endless material strips from such biopolymers therefore proves to be difficult. The strips often do not have the properties required for further processing, especially with respect to elongation at break and elasticity.

For instance, EP 0 397 819 shows a process for making thermoplastically processable starch, the crystalline content of the starch lying below 5%. The process comprises mixing native starch with at least 10% by weight of an additive which has a solubility parameter of at least 30.7 (MPa)^{1/2}. The mixture is transformed into a melt by supplying heat in a temperature range between 120° C. and 220° C., it being acceptable to assume an internal pressure of about 30 to 300 bar. The water content of the starch is already reduced to below 5% in the melt. Although this process produces a thermoplastic starch which can be processed well to form shaped bodies which have adequate strength, the elongation at break of the shaped bodies produced with this thermoplastic starch only achieves values of between 40% and 55%. The elasticity of the starch films is consequently too low for the production of one-part capsule shells in continuous processes and leads to tearing of the shaped parts during production or to tears in the finished capsule.

The starch film which is produced by the method disclosed in EP 397 819 also does not exhibit a suitability for fusing or strength of seam that would satisfy the quality requirements of one-part shells of shaped bodies, especially capsule shells.

In EP-A-1103254, which does not belong to the prior art, there is shown a process in which a thermoplastic starch-based composition is extruded under pressure and at temperatures of up to a maximum of 160° C. The rapid cooling of the extruded material strips caused by the great difference in temperature with respect to the surroundings, which is generally at a temperature of about 25° C., has the effect of producing a so-called glassy state, in which the long-chain polymer molecules are oriented. Although the strips produced in this way have adequate elongation at break of at least 100%, it has also been found that these material strips have conserved stresses. These are produced in particular by the orientation of the polymer molecules during the extrusion through the narrow gap of the die and by the slight tensile stress between the die gap and the chilling roller. Different mechanical properties in the longitudinal and transverse directions of the extruded strips are the consequence. These anisotropic material properties of the strips can have disadvantageous effects, in particular in downstream steps of the process. Deformations such as widening or shortening of the strips or of the shaped bodies produced from them may be the consequence.

This has especially disadvantageous effects if, in the case of a short residence time, the material strips are incompletely heated during filling of the shaped bodies and subsequent fusing. Stresses are in this case released in an uncontrolled manner. This may lead to asymmetrical and/or deformed shaped bodies. This cannot be tolerated for routine production in which the shaped bodies must have a dimensional stability of ±0.5 mm. In normal use and in processing, in particular packing, of the shaped bodies, however, the dimensional stability and esthetics of the shaped bodies constitute an extremely important and indispensable factor.

It is therefore the object of the present invention to provide a method and a device for producing shaped bodies from endless strips on the basis of biopolymers containing starch, which method and device permit the production of reproducible shaped bodies, especially whenever the basic composition of the strips is extruded under positive pressure and/or at high temperatures.

This object is achieved according to the invention by a method and a device having the features in the independent patent claims 1 and 8.

It was found that stresses of the material strips resulting from the extrusion of the material strips at high pressure and/or high temperature can be relieved by exposing the material strips to heat, especially directly before they are processed to form shaped bodies. The material strip is relieved of stress by exposure to heat. Conserved stresses are released before the material strips are processed to form shaped bodies and consequently can no longer influence the finished shaped body.

By the method according to the invention, the material strip is subjected to at least one heat treatment, preferably on both sides, at a treatment station between the extrusion tool and the shaping tool in order to relieve stresses.

The temperature and the duration for the treatment must be chosen such that the desired stress relief of the material strips occurs as a result and the strip can be guided in a controlled manner—without any further build-up of stress. This temperature is dependent on the process and material. The desired stress relief for the purposes of the invention is achieved when the strip no longer has anisotropic but isotopic mechanical properties after the heat treatment, so that the mechanical properties of the strip in the longitudinal direction and in the transverse direction are identical with good approximation. A definition of the pair of terms “anisotropic/isotropic” can be found in Römpp Chemie Lexikon, by: J. Falbe, M. Regitz, 9th edition, 1992, Georg Thieme Verlag, Stuttgart.

The strips treated according to the invention consequently have a uniform elongation at break and a uniform modulus of elasticity E, even over the entire material strip. For processing material strips to form shaped bodies, especially for producing soft capsules by the rotary-die process, an elongation at break of at least 100% and a modulus of elasticity of less than or equal to 2 MPa in the temperature range from 40° C. to 80° C. is particularly advantageous.

The elongation at break and the modulus of elasticity E may be measured in accordance with DIN standard 53455 or DIN. EN ISO 527-1 to ISO 527-3. According to this DIN standard, elongation at break is measured at the corresponding encapsulating temperature.

According to the invention, at least one material strip is extruded and subsequently exposed to heat in a treatment arrangement. It goes without saying that it is also possible, in accordance with the respectively chosen method for producing the shaped bodies, for a plurality of material strips to be extruded and subsequently subjected to a heat treatment.

For the purposes of the invention, the term shaped body is to be understood as meaning any kind of shaped bodies which are suitable for receiving a filling material and enclosing it inside in a sealing manner. These include not only capsules but also other forms, such as for example spheres, cushions and figures. Numerous further developments and departures from the basic principle of the capsule already exist.

For the purposes of the invention, biopolymer materials are all materials which contain starch or are based on starch and can be extruded by suitable methods to form endless material strips. These also include mixtures with other biopolymers, such as for example cellulose, in particular partly hydroxypropylated cellulose, alginates, carrageenans, galactomannans, glucomannans, casein.

The term starch is to be understood as meaning native starches, and also physically and/or chemically modified starches. For the base materials used in the method according to the invention, all starches, irrespective of the plant from which they are obtained, are suitable. In a preferred embodiment, it is starch with an amylopectin content which lies above 50% with respect to the total weight of the anhydrous starch. Potato starch is particularly suitable for this.

In the method according to the invention, however, all polyglucans in the broadest sense, i.e.. 1.4 and/or 1.6 poly-α-D-glucase and/or mixtures of these, are suitable.

The production of endless material strips on the basis of starch and process parameters and material properties are described in detail in EP-A-1103254. The content of this document is hereby expressly incorporated in the disclosure of the present patent application.

The method according to the invention may be an integral part of a known process for producing shaped bodies from endless material strips, such as for example the Norton, Banner or Scherer process or the processes by means of rotating forming rolls, as realized for example in the rotary-die process and in the Accogel process (“Die Kapsel”, by Fahrig/Hofer, Stuttgart, 1983; Lachmann/Liebermann/Kanig, “The Theory and Practice of Industrial Pharmacy”; Third Edition, Philadelphia 1986).

It is particularly preferred for at least two material strips to be processed by the rotary-die principle to form shaped bodies, each of the material strips being subjected to at least one heat treatment at a treatment station between extrusion and processing to form shaped bodies. The rotary-die process with rotating forming rolls has been known and customary for many years and today represents one of the most widespread methods of encapsulation for the production of pharmaceutical, dietary and technical shaped bodies.

In a particularly preferred exemplary embodiment, the endless material strips are exposed to heat on both sides. The heat treatment may in this case take place by radiation, in particular by IR radiation. Similarly, the use of ultrasound, microwave and other suitable sources of radiation are conceivable for the heating.

It is also conceivable for the heat treatment to be carried out by convective heat. In this case, the material strips are guided past a heating element or through a preheated hollow space of a treatment arrangement, in particular through a heating tunnel.

In the case of a further variant of the method according to the invention, the material strips are guided through a heatable bath, in particular an oil bath. Consequently, apart from the desired tension relief, a lubrication of the material strips can be achieved, and this may be particularly advantageous for further process steps. The bath temperature is preferably kept in the range between 40° C. and 80° C.

It is particularly advantageous if the tensile stress of the material strips is kept constant by a compensating means, in particular with the aid of at least one dancing roller. Excess lengths may occur, for example, as the result of unequal or fluctuating speeds of rotation of the advancing means, in particular rollers, responsible for the advancement of the endless material strips. Maintaining a constant longitudinal stress achieves the effect in particular of minimizing adverse influences on the material strips relieved of stress by the method according to the invention by exposure to heat.

The present invention also relates to a device for producing shaped bodies, especially capsules, from a biopolymer material containing starch, with at least one extrusion tool for extruding an endless material strip under pressure and at a temperature of over 50° C. and at least one forming tool for processing the material strip with the inclusion of a filling composition to form shaped bodies, at least one treatment station for exposing the material strip to heat being arranged between the extrusion tool and the forming tool.

In an exemplary embodiment, the treatment arrangement has at least one source of radiation, especially an infrared radiation source. Combinations of different sources of radiation are also conceivable.

It is also conceivable for the treatment station to have at least one heating element, the material strips being exposed to convective heat.

In the case of a further variant, the device according to the invention has a heatable bath, in particular an oil bath. Consequently, apart from the desired stress relief, a lubrication of the material strips can be achieved. An oil which is harmless from pharmaceutical and toxicological aspects during the later application of the shaped bodies is used in the oil bath. Such oils are known and listed in the relevant legislature. If appropriate, further additives which positively influence the properties of the material strips, such as for example elasticity or elongation at break, may be mixed in with the oil bath.

It is particularly advantageous if the device has between the oil bath and the forming tool at least one stripping device for stripping liquid off the surface of the material strips. The stripping device may in this case be designed in such a way that the film thickness of the film left behind on the surface of the material strips is predeterminable.

In a further preferred exemplary embodiment, the device has at least one compensating means, in particular a dancing roller, for maintaining a uniform longitudinal stress of the material strips. This dancing roller is advantageously arranged directly in a bath for the heat treatment, where it also serves the purpose of immersing the material strip below the level of the bath. This makes it possible to compensate for excess lengths of the strips, which are produced for example by advancement means that are not synchronous. In particular, the tensile stress can in this way also be kept as low as possible, particularly advantageously below 0.5 MPa.

In a particularly preferred exemplary embodiment, the forming tool of the device is a rotary-die device with two forming rolls and a filling wedge.

It is advantageous for the process control if at least one extrusion tool with an extrusion die is arranged on both sides of the forming tool in such a way that the material strip is introduced into the forming tool on a conveying plane without lateral deflection. The elimination of lateral deflections, as sometimes take place in particular when processing gelatin strips, prevents additional stresses that can lead to anisotropic material properties from reaching the strips.

It is particularly advantageous for the reasons mentioned if the device has at least one adjustable positioning arrangement, on which the extrustion tool and the forming tool can be adjusted in relation to each other. As a result, a rigid but adjustable arrangement of extrustion tool and the forming tool in relation to each other is achieved. Consequently, the transfer of stresses to the material strips as a result of the extrustion tool and the forming tool being unequally aligned is prevented. The positioning arrangement could have, for example, a machine frame for the extrusion tool which can be displaced on a rail.

Exemplary embodiments of the invention are described in more detail below and are represented in the drawings, in which:

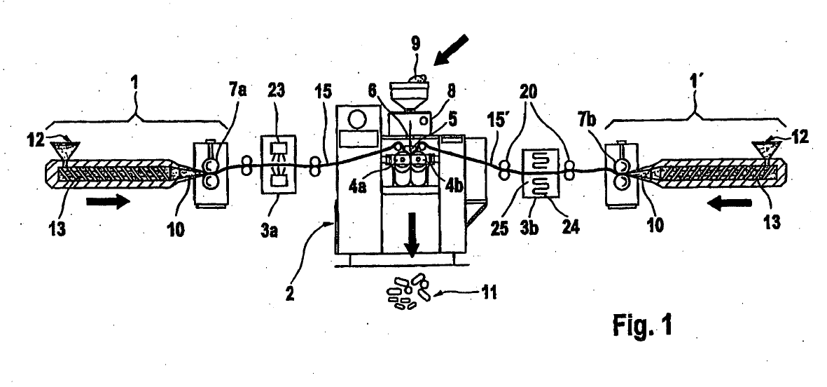

FIG. 1 shows a schematic representation of a device according to the invention for producing shaped bodies from endless material strips by the rotary-die process,

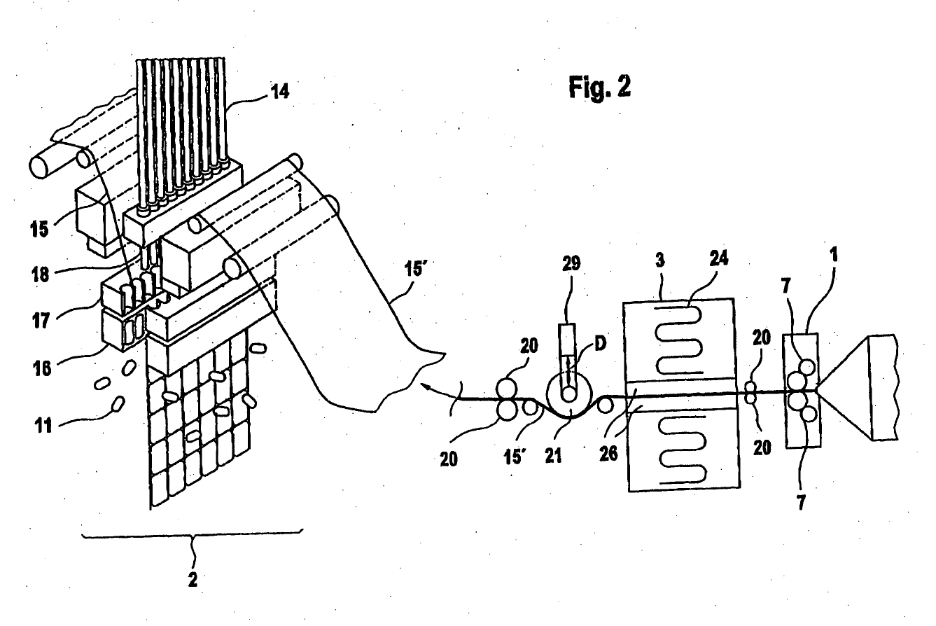

FIG. 2 shows a schematic representation of a device according to the invention for producing shaped bodies from endless material strips by the Norton process,

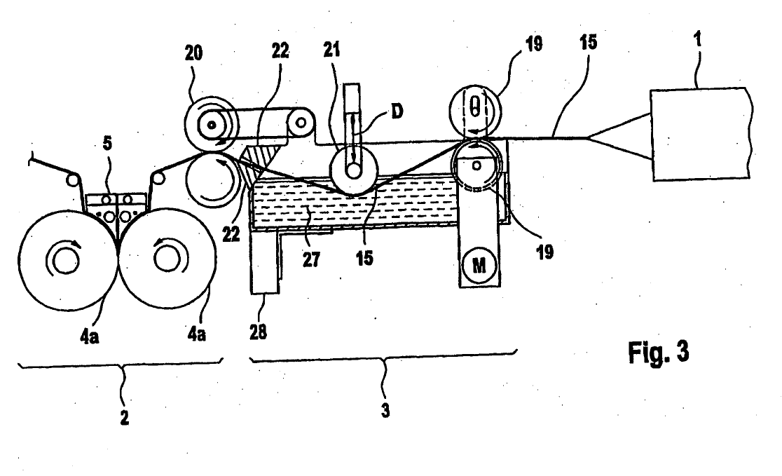

FIG. 3 shows a schematic representation of an alternative exemplary embodiment with a liquid bath,

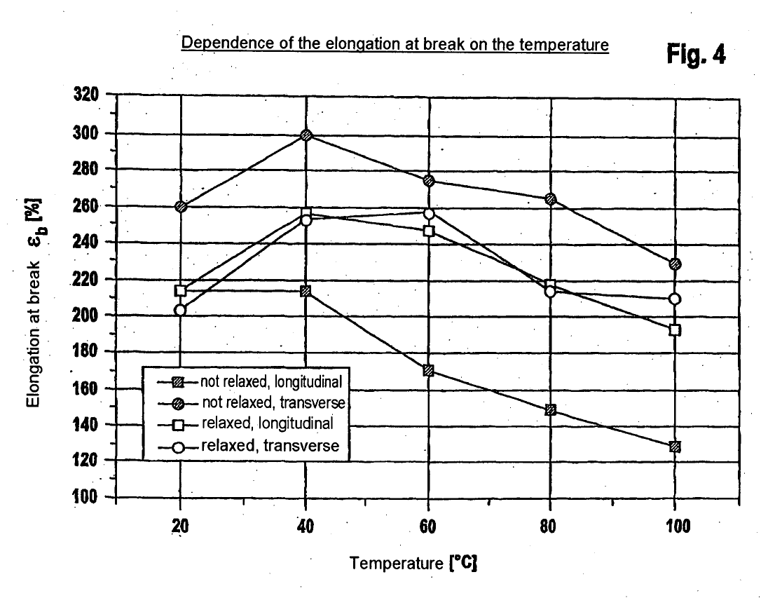

FIG. 4 shows a diagram of the elongation at break of starch strips before and after treatment by the method according to the invention, and

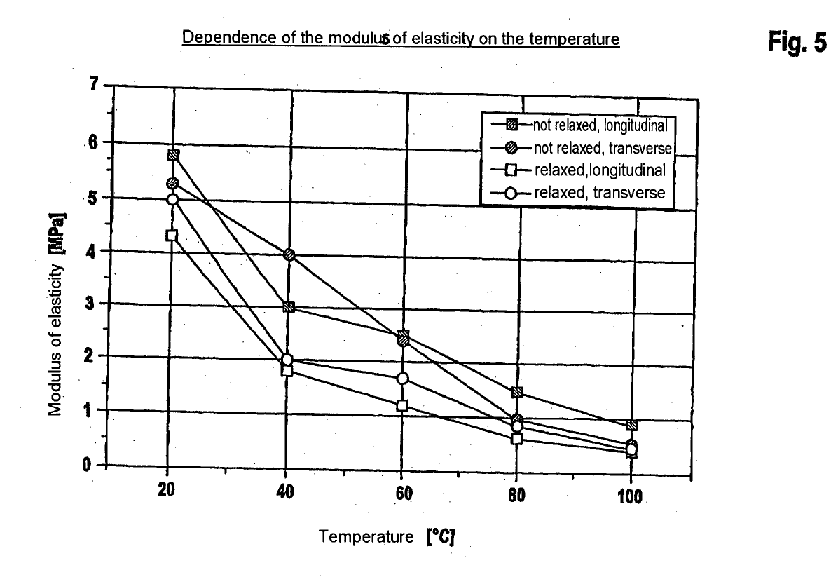

FIG. 5 shows a diagram of the Young's modulus of elasticity of starch strips before and after treatment by the method according to the invention.

FIG. 1 shows a schematic representation of a device according to the invention for producing shaped bodies from endless material strips by the rotary-die process. The rotary-die machine shown is used in a known way for the processing of two endless material strips 15, 15′. The material strips are in this case extruded at a respective extrusion tool 1, 1′ on the extruders 13 from slot dies 10 and drawn off by a respective pair of rolls 7a, 7b and rolled to a constant thickness. The extruders 13 are continuously supplied with biopolymer material 12, especially with starch-based material. The extruded material strips 15 are fed in a known way to a forming tool 2. Substantially horizontal feeding of the material strips to the forming tool is shown. It goes without saying that it is also conceivable for the material strips to be fed to the forming tool at some other angle. Vertical feeding is particularly advantageous here, because it allows the loading of the strip by gravity to be minimized.

The forming tool comprises two forming rolls 4a, 4b, the recesses required for the forming of the shaped bodies 11, especially into capsules, being arranged in the surfaces of the forming rolls 4a, 4b. Arranged in the drawing-in interstice of the pair of forming rolls 4a, 4b is a filling wedge 5, through which filling material 9 is introduced between the material webs 15, 15′ by means of a conveying pump 6 from a filling material tank 8, the material strips being formed into capsules 11 at the forming rolls 4a, 4b. Liquid, pasty or in certain cases also powdered filling material 9 may be used here as the filling material 9. The encapsulation of pellets, tablets and much more besides is also conceivable.

According to the invention, the material strips 15 are subjected to heat at a treatment arrangement 3a, 3b between the extrusion tool 1 and the forming tool 2. At the treatment arrangement 3a, the heat treatment takes place in the exemplary embodiment shown by radiation, for example from an infrared radiation source 23. It is also conceivable, however, as shown in the treatment arrangement 3b, for the material strips 15 to be heated by conductive heat, which is generated by heating elements 24, especially heating coils, and is emitted into a hollow space 25. For the advancement and guidance of the material strips 15, 15′, various guiding and/,or driving rollers 20 may be provided at corresponding points.

FIG. 2 shows a schematic representation of a device according to the invention for producing shaped bodies from endless material strips 15, 15′ by the Norton process. In this case, a respective material strip 15, 15′ is extruded from an extrusion tool 1 and drawn off by a pair of rolls 7 and rolled to the correct thickness. The material strip 15′ is guided through a treatment station 3 for exposure to heat in the region between the extrusion tool 1 and the forming tool 2. In the exemplary embodiment shown, the heat is generated by means of heating elements 24 in a heating tunnel 26. The material strip 15′ can be guided to the forming tool 2 by means of corresponding guiding and/or driving rollers 20.

It is particularly advantageous if, excess lengths of the material strips 15 which may be produced by asynchronous movements of the rollers 20, are compensated with the aid of a dancing roller 21. In this way, the longitudinal stress of the material strip 15 can be kept constant. The dancing roller 21 is correspondingly movable on an axis perpendicular to the running direction of the material strip 15 by a distance D required for maintaining the longitudinal stress of the material strip 15. By means of the dancing roller, the actual tensile stress can also be measured at a sensor 29. The sensor could therefore also be used for regulating the feed rate or for emergency shutdown in the event of an inadmissible tensile stress. It is particularly favorable if the tensile stress is kept below 0.5 MPa.

In the case of the Norton process, the material strip 15 is formed into shaped bodies 11, especially capsules, in the forming tool 2 in a known way. The forming of the capsules takes place between a unit for preforming 17 and a unit for capsule forming 16. In the upper parts of the units 16, 17, the capsules are preformed in the manner of tubes and filled via filling channels 18, which are supplied via a filling material feed 14. In the lower part of the unit for capsule forming, the final encapsulation takes place. With each step or with each pressing-apart and before the pressing-together of the units 16, 17, the material strip 15 moves forward by one capsule length in a straight line. As it does so, the capsule is preformed lengthwise in the upper forming part, the unit for preforming 17. It remains open at the top, to allow the filling material 9 to be metered in.

FIG. 3 shows a schematic representation of an alternative exemplary embodiment of a device according to the invention. In this case, the material strip 15 extruded from an extrusion die 1 is fed to an oil bath 27 by driving rollers 19, which are driven by a motor M. The oil bath 27 can be heated by means of a heating unit 28. By immersing the material strip 15 into the oil bath 27, on the one hand the desired stress relief of the material strip 15 is achieved by releasing conserved stresses. At the same time, the material strip 15 is lubricated by the oil bath 27. To compensate for excess lengths of the material strip 15, which may be produced for example by different rotational speeds of the driving rollers 19 and the guiding rollers 20, a dancing roller 21 is provided in the region of the oil bath 27. The dancing roller 21 is otherwise formed in the same way as in the exemplary embodiment according to FIG. 2.

In the exemplary embodiment shown, the material strip 15 is fed to a stripping device 22 when it leaves the oil bath 27. At the stripping device 22, excess oil can be removed from the surface of the material strip 15. The stripping device 22 may in this case be designed in such a way that the film thickness of the film left behind on the surface of the material strip 15 can be set to a predeterminable value. Subsequently, the stress-relieved material strip is fed to a forming tool 2 via guiding rollers 20, as already shown. In the exemplary embodiment shown, this is the forming tool 2 of a device operated by the rotary-die process. In the case of this process, it has a particularly favorable effect that additional heat has been introduced onto the starch strip 15, in the exemplary embodiment shown by the oil bath. This allows the segment temperature in the region of the filling wedge 5 to be kept low. Consequently, temperature-sensitive filling materials 9, especially active pharmaceutical substances, can also be encapsulated. Oiling the strip in the oil bath 27 makes it possible to dispense with additional oiling operations, which are usually necessary for process-related reasons. An oil bath 27 as a treatment station 3 for exposing the material strip 15 to heat has the extra advantage that further additives which positively influence the properties of the strip, such as viscosity, elasticity, elongation at break etc., can be mixed in with the bath. Other liquids instead of oil, such as for example water, aqueous dispersions etc., are conceivable.

FIG. 4 shows a diagram of the elongation at break of starch strips 15 before and after treatment by the method according to the invention. The elongation at break can be measured in accordance with DIN standard 53455. In FIG. 4, the elongation at break is shown in percent in dependence on the temperature. In this case, both the values for the elongation at break in the longitudinal direction and in the transverse direction of the starch strips 15 were determined. Here it is evident on the one hand that the elongations at break of at least 100% required for the forming operation on the material strip 15 to form a shaped body 11 are achieved over the entire temperature range, both in the longitudinal direction and in the transverse direction. This is important in particular because the minimum elongation at break of 100% is necessary in order to carry out encapsulation by existing rotary-die processes.

On the other hand, FIG. 4 clearly shows that the elongation at break in the longitudinal and transverse directions is different before the treatment by the method according to the invention. The starch strip has anisotropic mechanical properties, which are attributable in particular to conserved stresses produced during the extrusion of the strips. The processing of anisotropic strips may lead to malformed shaped bodies, especially capsules, which also have an increased tendency to become caught in the forming rolls and hinder the production process.

By contrast with this, the starch strip 15 is relaxed after treatment with heat and has isotropic properties. The measured elongation at break of the material strips 15 in the longitudinal direction and in the transverse direction is identical with good approximation. During the further processing of such material strips, uniform shaped bodies 11 are obtained, and they do not become caught in the forming rolls.

FIG. 5 shows a diagram of the modulus of elasticity of starch strips 15 before and after treatment by the method according to the invention. The modulus of elasticity E can be measured in accordance with DIN EN ISO 527-1 to ISO 527-3. The heat treatment has the effect of significantly lowering the modulus of elasticity, in particular in the range important for the processing of material strips 15 to form shaped bodies 11 of from 40° C. to 80° C., to be precise to 2 MPa and less. This is important in particular because a modulus of elasticity of at most 2 MPa is necessary to carry out encapsulation by existing rotary-die processes. For the encapsulation, the maximum pressure or the residence time of the material strips in the filling wedge region must necessarily be chosen such that the material strip can be “inflated” to form a capsule. The filling wedge in this case floats freely on the forming rolls and ensures the sealing. The pressure consequently cannot be increased unrestrictedly, since otherwise the filling material runs out between the material strip and the filling wedge.

Therefore, a low modulus of elasticity of the material strips 15 plays a decisive part. The method according to the invention consequently also proves to be particularly advantageous with regard to the lowering of the modulus of elasticity thereby achieved. Altogether, the material properties of the material strips are consequently optimized for the subsequent processing to form shaped bodies.

1. A method for producing shaped bodies, especially capsules, from a biopolymer material containing starch, in which at least one endless material strip (15) is extruded from an extrusion tool (13) under pressure and at a temperature of over 50° C. and processed in a forming tool (2) with the inclusion of a filling material at a plastifying temperature to form shaped bodies (11), the material strip being subjected to at least one heat treatment, preferably on both sides, at a treatment station (3) between the extrusion tool and the forming tool in order to relieve stresses.

2. The method as claimed in claim 1, characterized in that the duration and temperature of the heat treatment are set in such a way that the material strip has approximately isotropic mechanical properties in the longitudinal direction and in the transverse direction before reaching the forming tool.

3. The method as claimed in claim 1 or 2, characterized in that at least two material strips are processed on the basis of the the rotary-die principle to form shaped bodies, both material strips being subjected to at least one heat treatment at a treatment station between extrusion and processing to form shaped bodies.

4. The method as claimed in one of claims 1 to 3, characterized in that the heat treatment takes place by radiation from a source of radiation, in particular by IR radiation, or by convective heat.

5. The method as claimed in one of claims 1 to 3, characterized in that the heat treatment takes place by immersion of the material strip or the material strips in at least one heated bath, in particular an oil bath.

6. The method as claimed in claim 5, characterized in that the bath temperature is kept in a range from 40° C. to 130° C.

7. The method as claimed in one of claims 1 to 6, characterized in that the tensile stress of the material strip or the material strips is kept constant by a compensating means, in particular with the aid of at least one dancing roller (21).

8. A device for producing shaped bodies, especially capsules, from a biopolymer material containing starch, with at least one extrusion tool (13) for extruding an endless material strip (15) under pressure and at a temperature of over 50° C. and with at least one forming tool (12) for processing the material strip with the inclusion of a filling material to form shaped bodies (11), at least one treatment station (3) for exposing the material strip to heat, preferably on both sides, being arranged between the extrusion tool and the forming tool in order to relieve stresses.

9. The device as claimed in claim 8, characterized in that the treatment station for exposing the material strip to heat has at least one source of radiation, especially a source of radiation emitting an IR radiation, or at least one heating element.

10. The device as claimed in one of claims 8 to 9, characterized in that the treatment station for exposing the material strip to heat has a heatable bath, in particular an oil bath.

11. The device as claimed in claim 10, characterized in that at least one stripping device for stripping off liquid, in particular for metering the coating with liquid, is provided between the bath and the forming tool.

12. The device as claimed in one of claims 8 to 11, characterized in that it has at least one compensating means, in particular a dancing roller, for maintaining a constant tensile stress on the material strip.

13. The device in particular as claimed in one of claims 8 to 12, characterized in that it has at least one adjustable positioning arrangement, on which the extrustion tool and the forming tool can be adjusted in relation to each other with respect to their relative position.

14. The device as claimed in one of claims 8 to 13, characterized in that the forming tool (2) is a rotary-die device with two forming rolls and a filling wedge and in that at least one extrusion tool is arranged on each of both sides of the forming tool in such a way that the material strip is introduced into the forming tool on a conveying plane without lateral deflection.
